(19) United States
(12) Patent Application Publication
(10) Pub. No.: US 2012/0200541 A1
(43) Pub. Date: Aug. 9, 2012

(54) LCD AND DRIVING METHOD APPLICABLE THERETO

(75) Inventors: Wei-Hsiang HUNG, Hsinchu City (TW); Wei-Song HUANG, Hsinchu City (TW)

(73) Assignee: NOVATEK MICROELECTRONICS CORP., Hsinchu (TW)

(21) Appl. No.: 13/367,385

(22) Filed: Feb. 7, 2012

(30) Foreign Application Priority Data
Feb. 8, 2011 (TW) 100104142

(51) Int. Cl. G09G 5/00; G09G 3/36

(52) U.S. Cl. 345/204; 345/87

(57) ABSTRACT

Provided is a driving method applicable to an LCD. Whether to perform polarity conversion on a plurality of frames is determined respectively. The frames are displayed, wherein in a unit time, the number of times of converting the polarities of the frames is smaller than the number of times of updating the frames.

This application claims the benefit of Taiwan application Serial No. 100104142, filed Feb. 8, 2011, the subject matter of which is incorporated herein by reference.

### TECHNICAL FIELD

The disclosure relates in general to an LCD and a driving method applicable thereto, and more particularly to an LCD capable of reducing the number of frame polarity conversion and a driving method applicable thereto.

### BACKGROUND

FIG. 1 shows a function block diagram of a prior LCD 100. As indicated in FIG. 1, the LCD 100 at least includes a timing controller 110, a source driver 120 and a liquid crystal panel 130. The source driver 120 receives a signal generated by the timing controller 110, and further processes the signal to drive the liquid crystal panel 130 (such as charging or discharging liquid crystal cells of the liquid crystal panel 130).

Currently, frame rate conversion and dithering are used to enhance frame image quality and resolve motion blur. However, during the frame rate conversion, the timing controller 110 must output a large amount of data to the source driver 120 in a unit time, so that the source driver 120 must accordingly update a large amount of data in a unit time and perform more liquid crystal polarity conversion.

The LCD power consumption includes chip power consumption and panel power consumption. For LCDs, panel power consumption is larger than chip power consumption, and along with the increase in the frame update rate and the liquid crystal cell polarity conversion, panel power consumption also increases.

FIG. 2 shows a liquid crystal cell polarity conversion in each frame updating according to a prior art polarity conversion. As indicated in FIG. 2, frames 210 and 220 are original frames (assuming their frequencies are 60 Hz) and frames 210A-210D are interpolated frames. By interpolating frames, the frame update rate of LCD may be increased even though the original frame rate is not increased.

FIG. 3 shows several prior polarity conversion implementations such as column inversion, dot inversion and “M”H-“N”V inversion (“M”H-“N”V inversion), wherein M and N are positive integers, H and V respectively denotes row and column.

Panel power consumption is expressed as P=IV, and average alternating current is expressed as I=C*ΔV/T, wherein C denotes liquid crystal equivalent capacitance, ΔV denotes voltage variation, and T denotes cycle. If the frame update rate is higher (that is, the cycle T is shorter) and the polarities of liquid crystal cells are converted each time the frame is updated (which increases voltage variation ΔV), then the power consumed by each liquid crystal cell will increase accordingly, and LCD consumes more power and generates more heat.

Therefore, the disclosure provides an LCD and a driving method applicable thereto, which reduce the number of liquid crystal cell polarity conversion hence reducing the power consumed and the heat generated by LCD even though the frame update rate is not lowered.

### BRIEF SUMMARY OF THE DISCLOSURE

The disclosure relates to an LCD and a driving method applicable thereto. Polarity of original frames is converted but polarity of interpolated frames is not converted.

The disclosure relates to an LCD and a driving method applicable thereto, in which whether to perform polarity conversion on a frame is based on whether the frame include a vertical synchronization signal.

The disclosure relates to an LCD and a driving method applicable thereto, in which whether to perform polarity conversion on a frame is based on a frame update rate and a frame polarity conversion rate.

The disclosure relates to an LCD and a driving method applicable thereto, in which whether to perform polarity conversion on a frame is based on a number of total output vertical scan lines.

According to an exemplary embodiment of the disclosure, a driving method applicable to an LCD is provided. The method includes: determining whether to perform polarity conversion on each of a plurality of frames, respectively; and displaying the frames, wherein, in a unit time, a number of polarity conversion on the frames is smaller than a number of frame update on the frames.

According to another exemplary embodiment of the disclosure, an LCD is provided. The LCD includes a timing controller, a source driver and a display panel. The timing controller determines whether to perform polarity conversion on each of a plurality of frames, respectively. The source driver is coupled to the timing controller. The display panel is coupled to the source driver. In a unit time, a number of polarity conversions on the frames are smaller than a number of frame update on the frames.

It is to be understood that both the foregoing general description and the following detailed description are exemplary and explanatory only and are not restrictive of the disclosed embodiments, as claimed.

### BRIEF DESCRIPTION OF THE DRAWINGS

FIG. 1 (prior art) shows a function block diagram of a prior LCD;

FIG. 2 (prior art) shows a liquid crystal cell polarity conversion in each frame updating according to a prior art polarity conversion;

FIG. 3 (prior art) shows several prior polarity conversion implementations;

FIG. 4 shows a frame polarity conversion according to an embodiment of the disclosure;

FIG. 5 shows a liquid crystal polarity conversion according to the embodiment of the disclosure; and

FIGS. 6-8 are flowcharts of polarity conversion determination according to the embodiment of the disclosure.

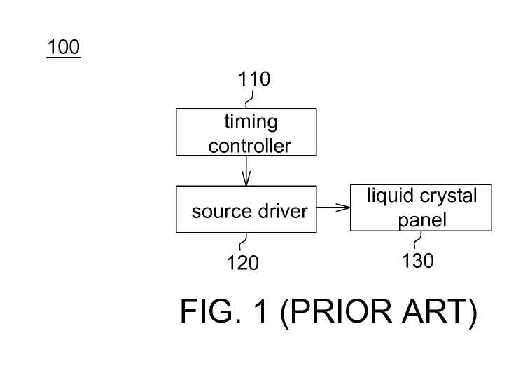

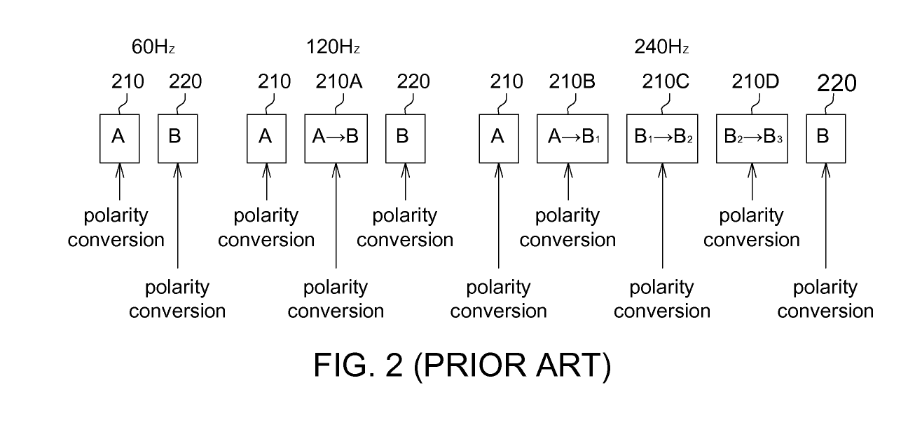

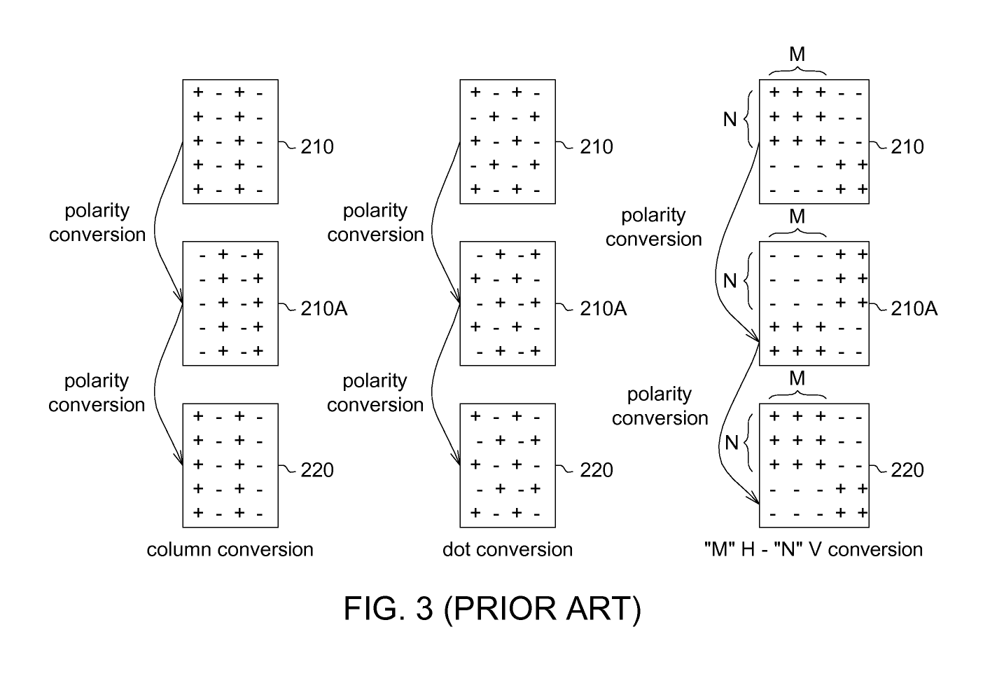

### DETAILED DESCRIPTION OF THE DISCLOSURE

In an embodiment of the disclosure, prior polarity conversion (that is, polarity of liquid crystal cells is converted at each time when the frame is updated) is not adopted. To the contrary, in the embodiment of the disclosure, the polarity of the liquid crystal cells of the frames with particular frequency is converted, and the polarity of the liquid crystal cells of the frames with other frequencies is not converted.

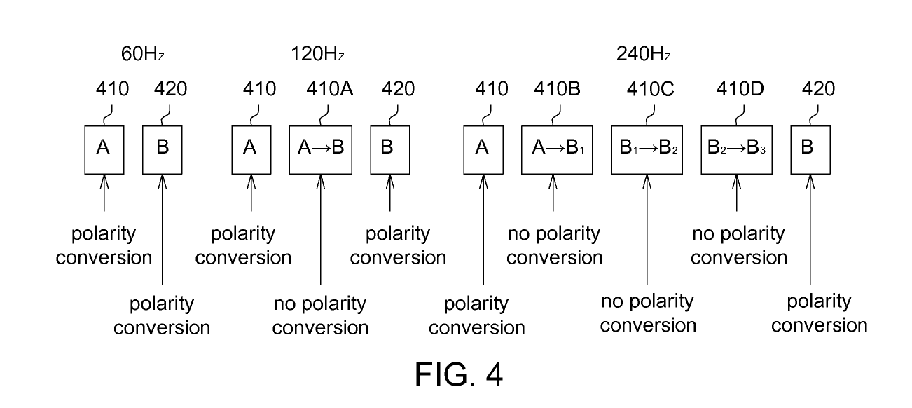

Referring to FIG. 4, a frame polarity conversion according to the embodiment of the disclosure is shown. Frames 410 and 420 are original frames (whose frequency is 60 Hz), and frames 410A˜410D are such as interpolated frames obtained by the timing controller.

As indicated in FIG. 4. Suppose that the frequency of the original frame is X (let X=60 Hz, that is, 60 original frames are received per second). If the frame update rate is Y (as indicated in the middle part of FIG. 4, Y equals 120 Hz, that is, 120 frames are displayed and or updated per second), the polarity of liquid crystal cells is converted every (Y/X) frames. As indicated in the middle part of FIG. 4, the polarity of liquid crystal cells is converted every Y/X=120/60=2 frames. In greater details, polarity conversion of liquid crystal cells is performed on the original frame 420 but not on the interpolated frame 410A. Besides, as indicated in the right-hand side of FIG. 4, the polarity of liquid crystal cells is converted every Y/X=240/60=4 frames. In greater details, if polarity conversion is performed on the original frame 410, then polarity conversion of liquid crystal cells is performed on the original frame 420 but not on the interpolated frames 410B˜410D.

Therefore, the embodiment of the disclosure is capable of reducing the number of liquid crystal cell polarity conversion. In the prior art, in a unit time (such as 1 second), when Y frames (regardless original frames or interpolated frames) are displayed, polarity of the liquid crystal cells is converted on each frame. To the contrary, according to the embodiment of the disclosure as indicated in FIG. 4, in a unit time (such as 1 second), when Y frames are displayed, polarity of the liquid crystal cells is converted on such as but not is not limited to the original frames but not on other frames (such as but not is not limited to the interpolated frames). Therefore, if frame update rate increases, in the embodiment of the disclosure, the number of polarity conversion is not increased much, hence saving LCD power consumption and heat generation.

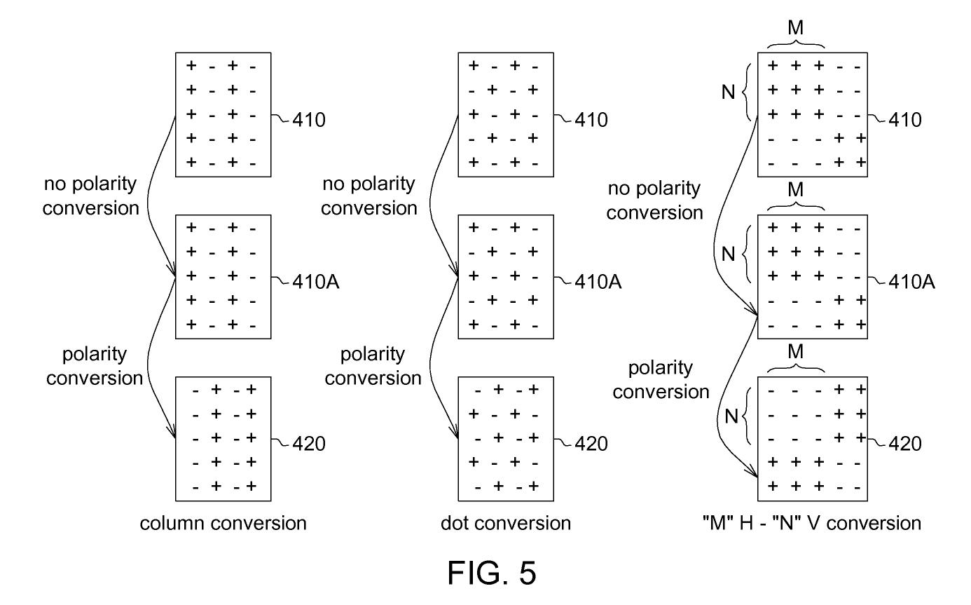

Referring to FIG. 5, a liquid crystal polarity conversion according to the embodiment of the disclosure is shown. As indicated in FIG. 5, the embodiment of the disclosure is applicable to column inversion, dot conversion, as well as any “M”H-“N”V inversion. Therefore, the embodiment of the disclosure is capable of reducing the number of polarity conversion of liquid crystal cells in a unit time, so that power consumed by the source driver in charging and/or discharging liquid crystal cells is reduced. The driving method of the embodiment of the disclosure is disclosed below for determining whether to perform polarity conversion on a frame.

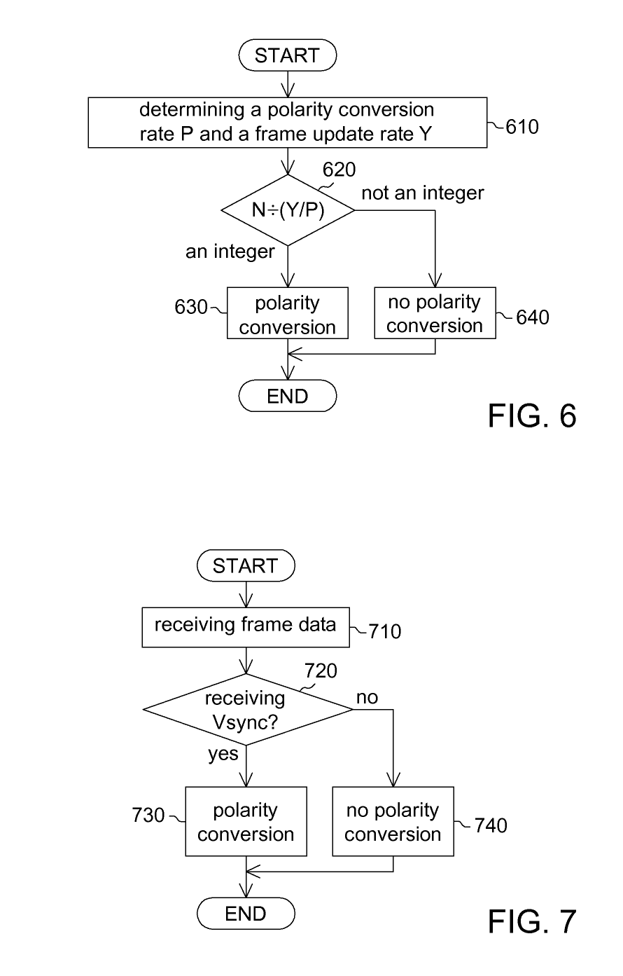

Referring to FIG. 6, a flowchart of a first polarity conversion determination according to the embodiment of the disclosure is shown. As indicated in FIG. 6, at step 610, a polarity conversion rate P and a frame update rate Y are determined. At step 620, whether N/(Y/P) is an integer is determined, wherein N denotes a number of the current frame (N being a positive integer). That is, N denotes the sum of the number of the original frames and the number of the interpolated frames (if any). If yes in step 620 (that is, N/(Y/P) is an integer), then the process proceeds to step 620, and polarity conversion is performed on the current frame. To the contrary, if no in step 620 (that is, N/(Y/P) is not an integer), then the process proceeds to step 640 and polarity conversion is not performed on the current frame. Please refer to the right-hand side of FIG. 4, let Y=240 and P=60. Suppose the frames 410, 410B, 410C, 410D and 420 are numbered 0, 1, 2, 3 and 4, respectively (i.e. N of the frames 410, 410B, 410C, 410D and 420 is 0, 1, 2, 3 and 4, respectively). As indicated in the determination result of FIG. 6, polarity conversion is performed when N=0 or 4 (that is, frames 410 and 420), that is, polarity conversion is performed on the frames 410 and 420; and polarity conversion is not performed when N=1, 2 or 3, that is, polarity conversion is not performed on the frames 410B˜410D.

However, the embodiment of the disclosure is not limited to such exemplification. For example, if the frequency of the original frames is 60 Hz, the embodiment of the disclosure may set the polarity conversion rate P as 30 Hz (that is, the polarity conversion rate P is smaller than the frequency of original frames). Moreover, even though the LCD does not have the function of inserting an interpolated frame (that is, the timing controller is unable to generated an interpolated frame), the flowchart of FIG. 6 is still applicable thereto.

Referring to FIG. 7, a flowchart of a second polarity conversion determination according to the embodiment of the disclosure is shown. Suppose the timing controller of LCD has the function of inserting interpolated frames. As indicated in FIG. 7, at step 710, frame data are received such as by the timing controller. Vertical synchronization signal Vsync is included in the original frame only, not in the interpolated frame. At step 720, whether the vertical synchronization signal Vsync is received is determined. If yes in step 720 (this implies that the current frame is an original frame), the process proceeds to step 730 and polarity conversion is performed on the current frame. To the contrary, if no in step 720 (this implies that the current frame is an interpolated frame, rather than an original frame), the process proceeds to step 740 and polarity conversion is not performed on the current frame. Please refer to the right-hand side of FIG. 4, the frames 410 and 420 are original frames (both include a vertical synchronization signal Vsync), so polarity conversion is performed on frame 410 and 420. To the contrary, since the frames 410B˜410D are interpolated frames, rather than original frames (i.e. frames 410B˜410D do not include a vertical synchronization signal Vsync), polarity conversion is not performed on the frames 410B˜410D.

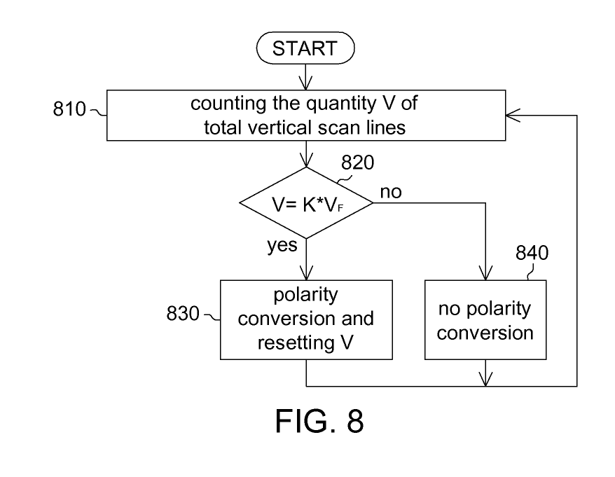

Referring to FIG. 8, a flowchart of a third polarity conversion determination according to the embodiment of the disclosure is shown. Here, the flowchart of FIG. 8 is applicable regardless the timing controller of an LCD has the function of inserting interpolated frame or not. As indicated in FIG. 8, at step 810, a quantity V of total vertical scan lines outputted to the source driver from the timing controller is counted such as by the timing controller. At step 820, whether V is equal to K*V_{F} is determined, wherein, V_{F} denotes the quantity of total vertical scan lines in one frame and K is a positive integer larger than 1. That is, after the previous polarity conversion, whether the timing controller already outputs K frames to the source driver is determined (regardless the frames are original frames or interpolated frames). If yes in step 820, then the process proceeds to step 830, polarity conversion is performed on the current frame and V is reset. To the contrary, if no in step 820, then the process proceeds to step 840 and polarity conversion is not performed on the current frame. Please refer to the right-hand side of FIG. 4 again, in case of full high definition, a hull high definition frame has a resolution of 1920/1080 (that is, V_{F}=1080). Assuming K=4. If polarity conversion is performed on the frame 410, then the next polarity conversion will be performed after K=4 frames (i.e. the polarity conversion is on the frame 420), but polarity conversion is not performed on the frames 410B˜410D.

According to the embodiment of the disclosure, the polarity conversion rate P is set to not damage liquid crystal cells. Experimental result shows that liquid crystal cells may be damaged after keeping at the same polarity for over 4 seconds. Ideally, liquid crystal cells will not be damaged as long as P is larger than ¼ Hz. If the value P is large, liquid crystal cells will be better protected but power-saving efficiency will deteriorate, and vice versa.

To summarize, the embodiment of the disclosure is of capable of reducing the number of polarity conversion of liquid crystal cells, hence reducing the power consumption and protecting the liquid crystal cells despite the frame update rate is not lowered.

It will be appreciated by those skilled in the art that changes could be made to the disclosed embodiments described above without departing from the broad inventive concept thereof. It is understood, therefore, that the disclosed embodiments are not limited to the particular examples disclosed, but is intended to cover modifications within the spirit and scope of the disclosed embodiments as defined by the claims that follow.

What is claimed is:

1. A driving method applicable to an LCD, including:
determining whether to perform polarity conversion on each of a plurality of frames, respectively; and
displaying the frames, wherein, in a unit time, a number of polarity conversion on the frames is smaller than a number of frame update on the frames.

2. The driving method according to claim 1, wherein, the step of determining whether to perform polarity conversion on each of the frames comprises:
performing polarity conversion on one of the frames if the one of the frames is an original frame; and
not performing polarity conversion on another one of the frames if the another one of the frames is an interpolated frame.

3. The driving method according to claim 1, wherein, the step of determining whether to perform polarity conversion on each of the frames comprises:
performing polarity conversion on a current frame if N/(Y/P) is an integer; and
not performing polarity conversion on the current frame if N/(Y/P) is not an integer, wherein, N is a current frame number, P is a polarity conversion rate, Y is a frame update rate, and P is smaller than Y.

4. The driving method according to claim 1, wherein, the step of determining whether to perform polarity conversion on each of the frames comprises:
performing polarity conversion on one of the frames if the one of the frames has a vertical synchronization signal; and
not performing polarity conversion on another one of the frames if the another one of the frames does not has a vertical synchronization signal.

5. The driving method according to claim 1, wherein, the step of determining whether to perform polarity conversion on each of the frames comprises:
counting a quantity V of total output vertical scan lines;
determining whether V is equal to K*V_{F}, wherein, V_{F} denotes a quantity of vertical scan lines in one frame, and K is any positive integer larger than 1; and
performing polarity conversion on a current frame and resetting V if V is equal to K*V_{F}, and not performing polarity conversion on the current frame if V is not equal to K*V_{F}.

6. An LCD, comprising:
a timing controller, used for determining whether to perform polarity conversion on each of a plurality of frames, respectively;
a source driver coupled to the timing controller; and
a display panel coupled to the source driver;
wherein, in a unit time, a number of polarity conversion on the frames is smaller than a number of frame update on the frames.

7. The LCD according to claim 6, wherein,
if the timing controller determines that one of the frames is an original frame, then polarity conversion is performed on the one of the frames; and
if the timing controller determines that another one of the frames is an interpolated frame, then polarity conversion is not performed on the another one of the frames.

8. The LCD according to claim 6, wherein,
if the timing controller determines that N/(Y/P) is an integer, then polarity conversion is performed on a current frame; and
if the timing controller determines that N/(Y/P) is not an integer, then polarity conversion is not performed on the current frame, wherein, N is a current frame number, P is a polarity conversion rate, Y is a frame update rate, and P is smaller than Y.

9. The LCD according to claim 6, wherein,
if the timing controller determines that one of the frames comprises a vertical synchronization signal, then polarity conversion is performed on the one of the frames; and
if the timing controller determines that another one of the frames does not comprise the vertical synchronization signal, then polarity conversion is not performed on the another one of the frames.

10. The LCD according to claim 6, wherein,
the timing controller counts a quantity V of total output vertical scan lines;
the timing controller determines whether V is equal to K*V_{F}, wherein, V_{F} denotes a quantity of total vertical scan lines in one frame, and K is any positive integer larger than 1; and
if yes, then polarity conversion is performed on a current frame and V is reset; and if no, polarity conversion is not performed on the current frame.
